(19) United States
(12) Patent Application Publication
(10) Pub. No.: US 2013/0016439 A1
(43) Pub. Date: Jan. 17, 2013

(54) TAPE REWIND TO LIMIT AIR ENTRAPMENT

(71) Applicants: ARMANDO J. ARGUMEDO, TUCSON, AZ (US); JOSEPHINE F. BAYANG, TUCSON, AZ (US); ERNEST S. GALE, TUCSON, AZ (US); REED A. HANCOCK, TUCSON, AZ (US); EIJI OGURA, KANAGAWA (JP)

(72) Inventors: ARMANDO J. ARGUMEDO, TUCSON, AZ (US); JOSEPHINE F. BAYANG, TUCSON, AZ (US); ERNEST S. GALE, TUCSON, AZ (US); REED A. HANCOCK, TUCSON, AZ (US); EIJI OGURA, KANAGAWA (JP)

(73) Assignee: INTERNATIONAL BUSINESS MACHINES CORPORATION, ARMONK, NY (US)

(21) Appl. No.: 13/181,352

(22) Filed: Jul. 12, 2011

(51) Int. Cl. G11B 15/00; G11B 15/48

(52) U.S. Cl. 360/73.07; 360/90; G9B/15; G9B/15.07

(57) ABSTRACT

In a tape drive having a rotatable take-up reel supporting an end of an elongate tape, a drive control system for rotating the take-up reel and for rotating a tape supply reel of a removable tape cartridge. The drive control system is arranged to tension and move the elongate tape between the reels. At rewind, the drive control system rewinds the elongate tape onto the supply reel at rewind velocity under tension; upon the rewinding approaching the end of the elongate tape, rewinds the elongate tape at a reduced velocity under tension, the reduced velocity less than 60% of the rewind velocity; and stops the reduced velocity rewinding for a period of time and maintains the elongate tape in a dwell state under tension which is greater than an operating tension during tape motion. The dwell state time period may be substantially 10 seconds.

### DOCUMENTS INCORPORATED BY REFERENCE

Commonly assigned U.S. Pat. No. 6,836,386, issued Dec. 28, 2004, is incorporated for its showing of a tape drive system. Commonly assigned U.S. Pat. No. 6,817,560, issued Nov. 16, 2004, is incorporated for its showing of a tension control for tape.

### FIELD OF THE INVENTION

This invention relates to tape drives for moving an elongate tape between a supply reel and a take-up reel, for example for writing and reading data on the elongate tape.

### BACKGROUND OF THE INVENTION

The ability of elongate tape in a given size reel to store greater amounts of data can be enhanced by making the elongate tape thinner, thereby allowing the same size reel to store a greater length of the tape. But, as the tape becomes thinner, it also becomes more delicate and must be handled more carefully in a tape drive as the tape drive moves the elongate tape between a supply reel and a take-up reel.

Typically, an elongate tape, such as a magnetic data storage tape, is provided from a supply reel of a tape cartridge to the tape drive take-up reel, and when the tape is no longer needed for writing or reading data, it is rewound from the tape drive take-up reel back onto the tape cartridge supply reel. This rewind process is typically done at a high linear speed, and it has been observed that the tape pack can entrap air when the tape is rewound. The tape cartridge is typically removed from the tape drive and saved for later use, for example on a storage shelf. While it is saved, the entrapped air can bleed out, and develop slack in the outer wraps of the tape pack. If the tape pack is vibrated such as in shipping, the slack outer wraps can allow some of the more tightly packed inner wraps to loosen and cause a longitudinal bunching of tape that is called “cinching”. When “cinching” occurs, the tape can become damaged locally which in turn can cause read and write errors.

### SUMMARY OF THE INVENTION

Tape drives, methods, and drive control systems are provided for handling elongate tape.

In one embodiment, a tape drive comprises a rotatable take-up reel supporting an end of an elongate tape, and a drive control system for rotating the take-up reel and for rotating a supply reel of a removable tape cartridge, where the supply reel supports the other end of the elongate tape. The drive control system is arranged to move the elongate tape between the supply reel and the take-up reel and to develop tension between the supply reel and the take-up reel with respect to the elongate tape. The drive control system:

rewinds the elongate tape onto the supply reel at rewind velocity under tension;

upon the rewinding approaching an end of the elongate tape, rewinds the elongate tape at a reduced velocity under tension, the reduced velocity less than 60% of the rewind velocity; and

stops the reduced velocity rewinding for a period of time and maintains the elongate tape in a dwell state under tension.

In a further embodiment, the dwell state tension is greater than the operating tension during tape motion.

In a still further embodiment, dwell state tension comprises at least 50% greater tension than the operating tension during tape motion.

In another embodiment, the dwell state period of time comprises substantially 10 seconds.

In yet another embodiment, the drive control system conducts the reduced velocity rewind for at least 60 revolutions of the supply reel comprising at least 60 wraps of the elongate tape onto the supply reel.

In a further embodiment, the elongate tape comprises a magnetic data storage tape whose end comprises a leader that is coupled to the take-up reel, and wherein the drive control system follows the rewinding steps with an unspool step which unspools all of the magnetic tape from the take-up reel onto the supply reel, and the unspool step precedes the dwell state step.

In another embodiment, the drive control system comprises a computer program product comprising non-transient computer-usable storage medium having computer-usable program code embodied therein, the computer-usable program code operating at least one computer processor system to operate the supply and take-up reels.

For a fuller understanding of the present invention, reference should be made to the following detailed description taken in conjunction with the accompanying drawings.

### BRIEF DESCRIPTION OF THE DRAWINGS

FIG. 1 is a partially cut away view of an exemplary tape drive with a tape cartridge and elongate tape which may implement aspects of the present invention;

FIG. 2 is view of the tape cartridge of FIG. 1;

FIG. 3 is a schematic view of the tape drive with a tape cartridge and elongate tape of FIG. 1;

FIG. 4 is a block diagram of a drive system of FIG. 3;

FIG. 5 is a diagrammatic illustration of an elongate tape of FIG. 1;

FIG. 6 is a flow chart depicting an exemplary method of operating the system of FIGS. 1, 2, 3 and 4; and

FIGS. 7 and 8 are diagrammatic illustrations of states of the elongate tape of FIGS. 1, 2, 3 and 4.

### DETAILED DESCRIPTION OF THE INVENTION

This invention is described in preferred embodiments in the following description with reference to the Figures, in which like numbers represent the same or similar elements. While this invention is described in terms of the best mode for achieving this invention's objectives, it will be appreciated by those skilled in the art that variations may be accomplished in view of these teachings without deviating from the spirit or scope of the invention.

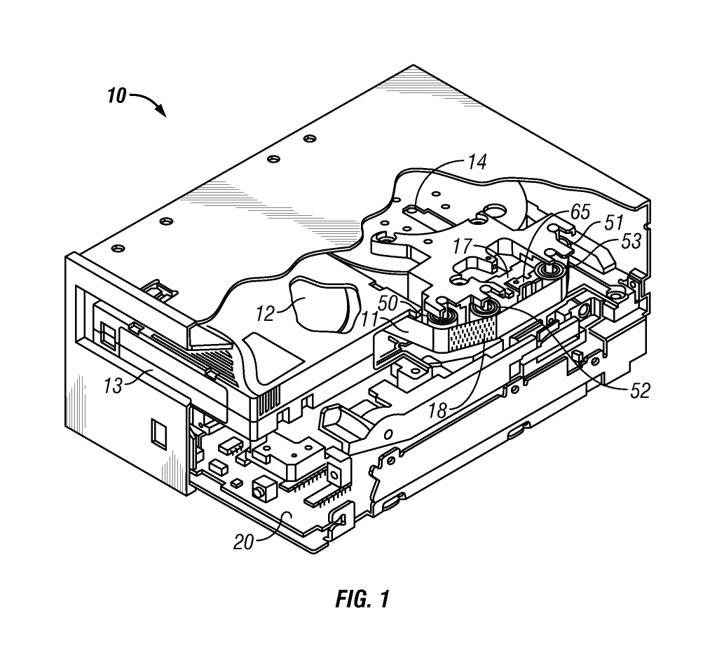

FIG. 1 illustrates an example of a tape drive 10, which may comprise a magnetic tape data storage drive which writes data 18 to and reads data from an elongate tape 11 which may comprise magnetic tape data storage media. As is understood by those of skill in the art, magnetic tape data storage drives, also called magnetic tape drives or tape drives, may take any of various forms. The illustrated magnetic tape drive 10 moves the elongate tape 11 along a tape path in the longitudinal direction of the tape from a supply reel 12 in a magnetic tape data storage cartridge 13 to a take up reel 14. An example of a magnetic tape drive is the IBM® LTO (Linear Tape Open) magnetic tape drive. Another example of a magnetic tape drive is the IBM® TotalStorage Enterprise magnetic tape drive. Both the above examples of magnetic tape drives employ single reel tape cartridges 13.

The magnetic tape media 11 is moved in the longitudinal direction across a tape head 65. The tape head may be supported and laterally moved by a compound actuator 17 of a track following servo system. The magnetic tape media is supported by roller tape guides 50, 51, 52, 53, while the magnetic tape media is moved longitudinally.

A typical magnetic tape data storage drive operates in both the forward and reverse directions to read and write data. Thus, the magnetic tape head 65 may comprise one set of read and write elements for operating in the forward direction and another set for operating in the reverse direction, or alternatively, may have two sets of the write elements on either side of the read elements to allow the same read elements to read in both directions while the two sets of write elements allow a read-after-write in both directions.

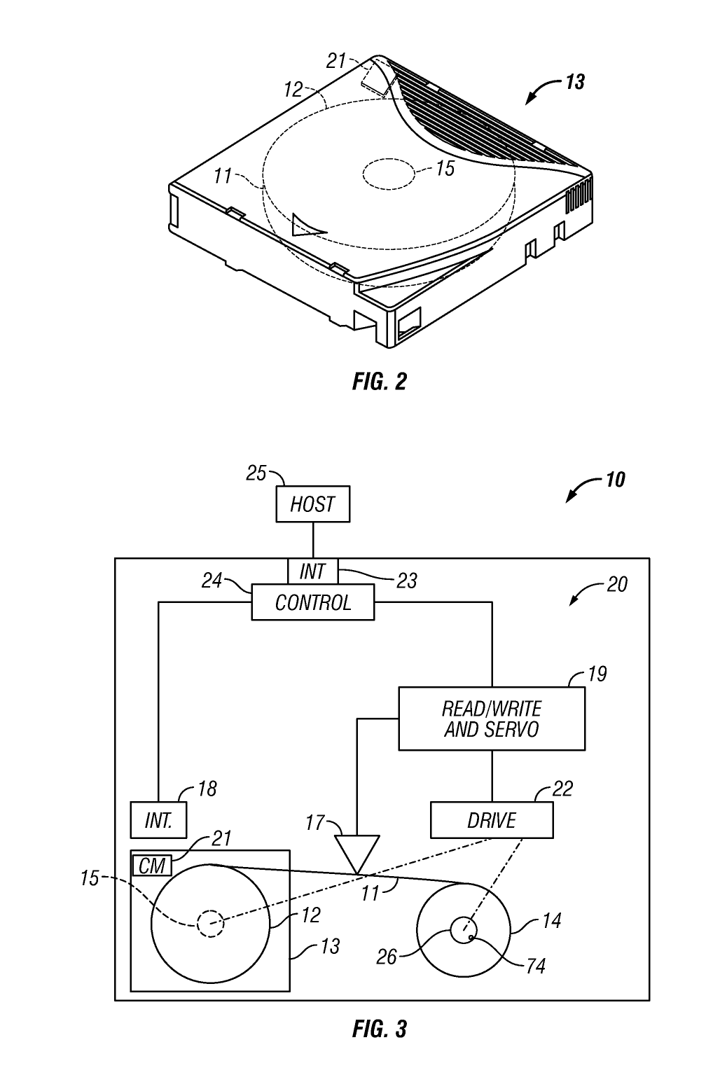

Referring to FIG. 2, the single reel tape cartridge 13 comprising an elongate tape 11, such as magnetic tape, is illustrated wherein the elongate tape 11 is wound on a hub 15 of reel 12. A cartridge memory 21 may store information regarding the data storage cartridge and, for example, comprises a transponder.

Referring to FIG. 3, the magnetic tape drive 10 is illustrated wherein the magnetic tape 11 is wound on reel 12 in the cartridge 13, and, when loaded in the magnetic tape drive 10, is fed between the cartridge reel and a take up reel 14 in the magnetic tape drive.

The magnetic tape drive comprises a memory interface 18 for reading information from, and writing information to, the cartridge memory 21 of the magnetic tape cartridge 13. A read/write system is provided for reading and writing information to the magnetic tape, and, for example, may comprise a read/write and servo head system 17 with a servo system for moving the head laterally of the magnetic tape 11, a read/write servo control 19, and a drive system 22 which moves the magnetic tape 11 between the cartridge reel 12 and the take up reel 14 and across the read/write and servo head system 17. A control 24, read/write servo control 19, and drive system 22 form a drive control system 20. The read/write and servo control 19 controls the operation of the drive system 22 to move the magnetic tape 11 across the read/write and servo head system 17 at a desired velocity, and, in one example, determines the lateral location of the read/write and servo head system with respect to the magnetic tape 11, and, in another example, determines the longitudinal position of the tape 11 by reading the tape servo tracks, for example, called “LPOS” (Longitudinal POSition), and in another example, the read/write and servo control 19 employs signals from the reel motors to determine the location of the read/write and servo head system with respect to the magnetic tape 11.

An interface 23 provides communication with respect to one or more host systems or processors 25, and is configured to receive and to send information externally of the data storage drive. Alternatively, the tape drive 10 may form part of a subsystem, such as a library, and may also receive commands from the subsystem, also at interface 23.

A control 24 communicates with the host interface 23, with memory interface 18, and communicates with the read/write system, e.g., at read/write and servo control 19. The illustrated embodiments of tape drives are known to those of skill in the art. The control 24 also controls the read/write and servo control 190 and drive system 22.

Other types of removable data storage cartridges and tape drives are known to those of skill in the art. Examples comprise optical tape cartridges and drives.

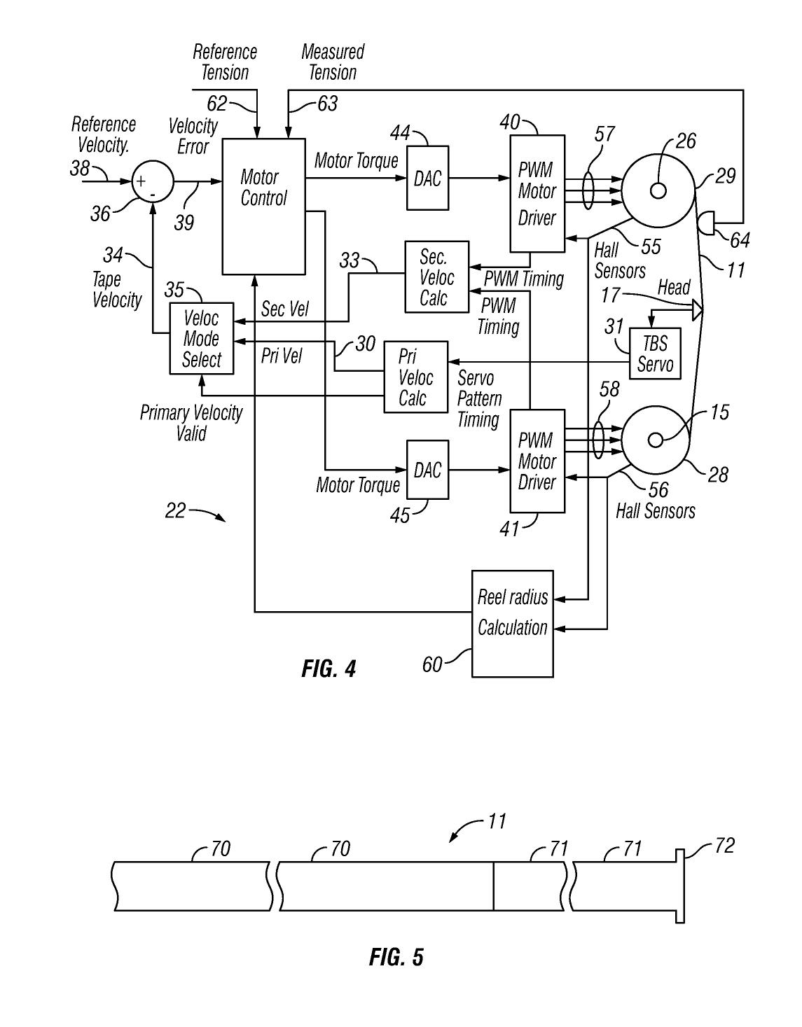

Referring to FIG. 4, the drive system 22 comprises an example of a system for moving the tape 11 longitudinally between reels 12 and 14 of FIG. 3 whose hubs 15 and 26 are driven by DC motors 28 and 29. One example, such as illustrated in FIG. 4, is discussed in the incorporated '386 patent where a primary velocity signal 30 is derived from the detection 31 of a formatted servo track on the tape 11, such as a timing based servo (TBS) generated from the tape head 17, and a secondary velocity signal 33 is derived from signals relating to the back-EMF of the DC motors 28 and 29. The velocity signal 34 is selected from the primary or secondary velocity signals by logic 35 and compared 36 to a reference tape velocity 38 provided by the control 24 of FIG. 3 to determine a velocity error 39.

The tape reels 12 and 14 of FIG. 3 are driven, in FIG. 4, by DC motors 28, 29, for example comprising brushless DC motors. The DC motors are driven by PWM (pulse width modulation) motor drivers 40, 41 with current-mode or transconductance amplifiers, as is known to those of skill in the art. The amplifiers have current sense circuits which produce a motor current signal that is subtracted from a reference current supplied by a DAC (digital to analog converter) 44, 45. The difference between the current reference and the current sense produces an error current signal that is amplified and filtered in a compensator circuit that produces a motor control signal. This signal drives a pulse width modulator (PWM) which produces a digital signal that continually reverses the polarity of the voltage that is applied to the DC motor. The PWM signal is fed to a commutator circuit which is also controlled by commutation sensors (Hall sensors) 55, 56 that sense the motor armature position and select the proper motor winding that is to be excited by means of winding excitation lines 57, 58.

The drive system 22 is a multiple input, multiple output (MIMO) system that computes two control values for the plant, which is made up of the two motors 28, 29, two tape reels, and the tape path connecting the two reels. This is so that the reels are rotated at the appropriate, usually different, rotational velocities, as determined by reel radius calculation 60, such that the tape 11 is moved from one tape reel having one diameter of tape, to another tape reel having another diameter of tape, at the same longitudinal velocity.

The drive system is further arranged to provide tension to the tape during tape motion by applying slightly greater torque to the leading reel to which the tape 11 is being wound or rewound than is provided to the lagging reel from which the tape is being supplied. The desired reference tension 62 is provided by the control 24 of FIG. 3. As an example, operating tension during tape motion may comprise substantially 0.6 Newtons.

An example of the application of tension is provided by the incorporated '560 patent, employing various techniques to set and maintain a desired reference tension, for example to minimize the error between a measured tension 63 from a tension transducer 64 and the reference tension 62.

Other drive systems may be provided as are known to those of skill in the art.

An exemplary tape 11 is illustrated in FIG. 5, comprising data tape, such as a magnetic data storage tape 70 whose end comprises a leader 71 with a pin 72 that may be loaded into and coupled to the take-up reel. For example, pin 72 may be loaded into and coupled to hub 26 of take-up reel 14 at point 74 of FIG. 3.

Referring to FIGS. 3, 5 and 6, when the cartridge 13 is loaded in the tape drive 10 and the data storage activity with respect to the tape 11 has been completed, the drive control system 20 rewinds the tape 11 from the take-up reel 14 back into the supply reel 12. This rewind process is done initially at a high linear speed in step 75, the linear speed essentially the same as the typical rewind process.

In accordance with one embodiment, step 77 determines whether rewind process approaches the end of the tape having the leader 71. In one embodiment, the position of the tape 11 is determined from the longitudinal position (LPOS) information of the TBS servo detection 31 of FIG. 4 as is known by those of skill in the art. If the end of tape is distant, the rewind process continues in step 75.

Still referring to FIGS. 3, 5 and 6, the end of tape of step 77 is a specific window comprising a point at which a defined length of tape 11 remains to be rewound. In one embodiment, the defined length of data storage tape is equivalent to a defined number of wraps of tape at the supply reel 12 comprising a defined number of revolutions of the supply reel. In one embodiment, the number of wraps remaining comprises at least 60 wraps plus the number of wraps required to unspool the tape 11 from the take-up reel 14 and then to unthread the tape. In one example, the window comprises the point at which there are substantially 85 revolutions to go. At this point, the magnetic data storage tape 70 is still being rewound, and the leader 71 is still wound on the take-up reel 14.

In one embodiment, a way of determining whether the window has been reached is to conduct a high speed locate operation to the desired position, for example, as determined by reading the LPOS information. An alternative, the revolutions of the supply or take-up reels may be tracked throughout the use of the tape 11, for example by the Hall sensors 55, 56 of FIG. 4 or by a tachometer, and used to determine whether the window has been reached.

Still referring to FIGS. 3, 5 and 6, in response to step 77 determining that the window has been reached, the drive control system, at step 80, rewinds the tape 11 in step 78, but at a reduced velocity. As one example, the rewind or high speed locate operation of step 75 may comprise 8 meters per second and the reduced velocity rewind of step 78 may comprise 4 meters per second, substantially 50% of the high speed rewind. The reduced velocity rewind of step 78 is conducted at the same, or substantially the same, operating tension during tape motion as the high speed rewind. As discussed above, in one example, the tension comprises substantially 0.6 Newtons.

The reduced velocity rewind of step 78 allows for less air to become entrapped, and is continued for a substantial number of revolutions of the supply reel 12. In one embodiment, the reduced velocity rewind continues for at least 60 revolutions of the supply reel 12 comprising at least 60 wraps of the elongate tape 11 onto the supply reel. In one example, the reduced velocity rewind continues for 63 revolutions of the supply reel.

When the reduced velocity rewind completes, at step 80, the remainder of the tape 11, including leader 71, is unwrapped from the take-up reel 14 in an unspool operation. The unspool operation slowly removes the tape from the take-up reel and places it on the supply reel 12, leaving the leader pin 72 coupled to the take-up reel 14, as shown by hub 26 of take-up reel 14 at point 74 of FIG. 3. The unspool operation continues for about 23 revolutions of the supply reel and is conducted for example at substantially 1 meter per second.

Still referring to FIGS. 3, 5 and 6, in one embodiment, after the unspool operation of step 80 completes, in step 82, the drive control system 20 holds both reels 12, 14 motionless in a dwell state and applies greater tension to the tape 11. The tension is applied to the tape at the leader pin 72 at take-up reel 14 and through the tape wound on supply reel 12. In one embodiment, the dwell state tension comprises at least 50% greater tension than the operating tension during tape motion. In one example, the dwell state tension of step 82 is 1 Newton as compared to the 0.6 Newton tension of the operating tension during tape motion of steps 75 and 78.

In one embodiment, the dwell state tension of step 82 is held for a period of time comprising substantially 10 seconds. The extended dwell state at the greater tension allows entrapped air to bleed out of the tape 11 as wound on supply reel 12.

Then, in step 85, the leader pin 72 is removed from the take-up reel and inserted at the cartridge 13 and the cartridge is unloaded from the tape drive 10.

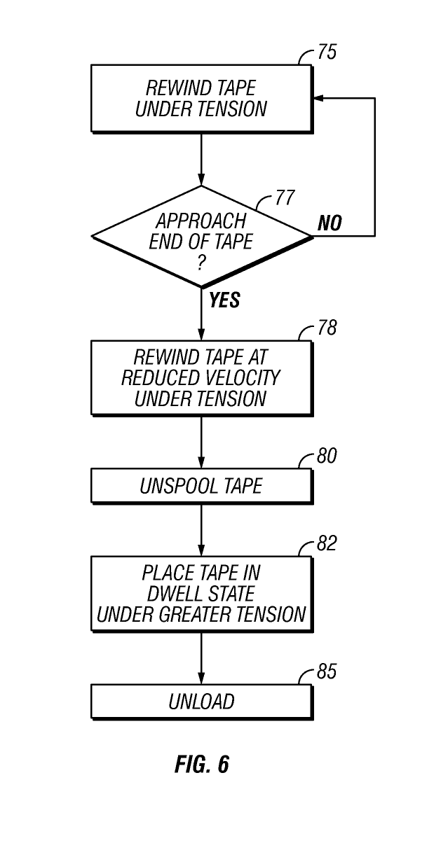

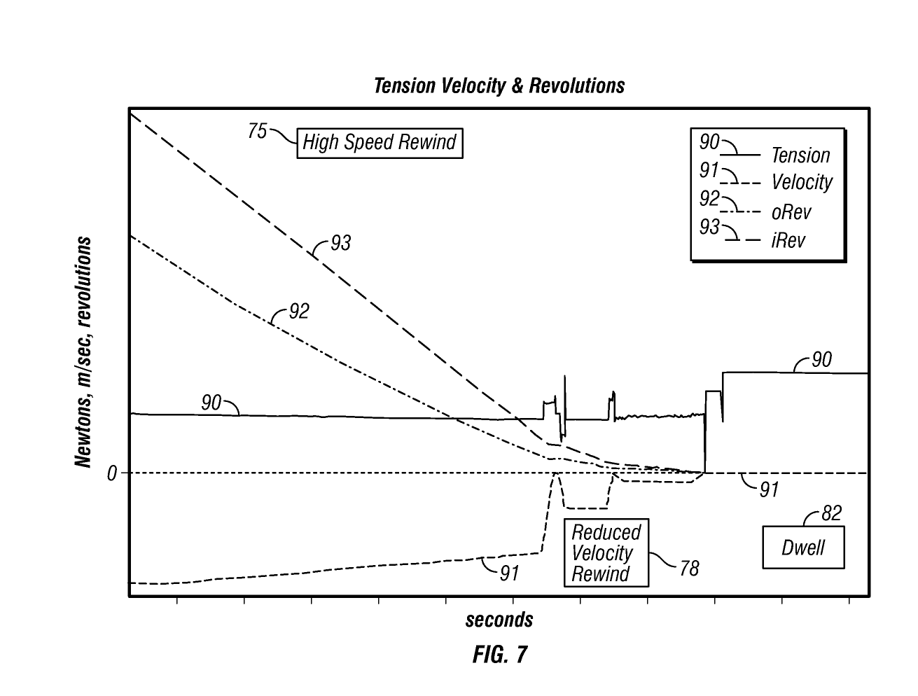

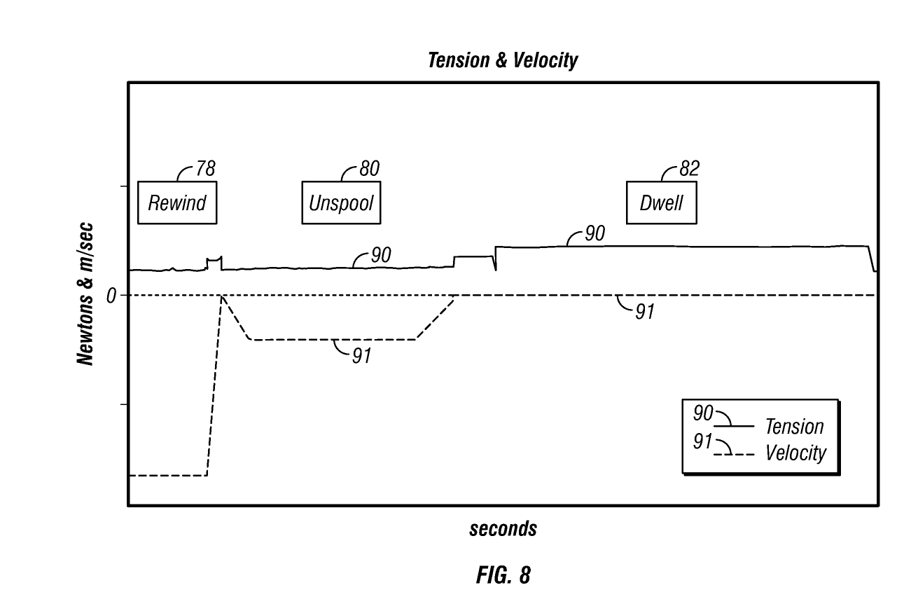

FIGS. 7 and 8 illustrate a specific example of the process of FIG. 6. The tension applied to the tape is illustrated by plot traces 90, the velocity of the tape is illustrated by plot traces 91, the revolutions of the outboard motor and supply reel are depicted by plot trace 92, and the revolutions of the inboard motor and take-up reel are depicted by plot trace 93.

FIG. 7 is directed to the end of the rewind and reduced velocity rewind operations of steps 75 and 78 and FIG. 8 is focused on the dwell state 82.

Thus, in FIG. 7, and also referring to FIG. 6, during the high speed rewind step 75, the tension 90 remains constant while the speed of the rewind 91 (shown as a negative since it is in the reverse or rewind direction) slows slightly and the revolutions 92 of the outboard or supply reel and the revolutions 93 of the inboard or take-up reel decrement towards zero, which is the starting point for the revolutions counts.

The plots show a transition to the reduced velocity rewind of step 78. During step 78, the tension remains constant and is substantially the same as the tension during the rewind step 75. However, the speed 91 of the reduced velocity rewind 78 is reduced considerably from that of the rewind step 75. The reduced velocity rewind of step 78 allows for less air to become entrapped by the tape.

Referring additionally to FIG. 8, the unspool step 80 is conducted, again at the same tension 90.

Ultimately, the dwell step 82 is reached with the revolutions of the reels reaching the zero point and the velocity plot 91 showing that the tape is stopped. During the dwell period 82, a greater tension 90 is applied to the tape for a period of time. The extended dwell state at the greater tension allows entrapped air to bleed out of the tape wound on supply reel.

A person of ordinary skill in the art will appreciate that the embodiments of the present invention, disclosed herein, including the drive control system 20 of FIG. 3, and the functionality provided therein, may be embodied as a system, method or computer program product. Accordingly, embodiments of the present invention may take the form of an entirely hardware embodiment, an entirely software embodiment (including firmware, resident software, micro-code, etc.) or a combination thereof, such as an embodiment combining software and hardware aspects that may all generally be referred to herein as a “circuit,” “module” or “system.” Furthermore, embodiments of the present invention may take the form of a computer program product embodied in one or more non-transient computer readable medium(s) having computer readable program code embodied thereon. For example, an embodiment of the present invention may comprise changes to the microcode of control 24.

Any combination of one or more non-transient computer readable medium(s) may be utilized. The computer readable medium may be a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Program code embodied on a computer readable medium may also be transmitted using any appropriate medium, including but not limited to wireless, wireline, optical fiber cable, RF, etc., or any suitable combination of the foregoing.

Computer program code for carrying out operations for embodiments of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Embodiments of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Those of skill in the art will understand that changes may be made with respect to the methods discussed above, including changes to the ordering of the steps. Further, those of skill in the art will understand that differing specific component arrangements may be employed than those illustrated herein.

While the preferred embodiments of the present invention have been illustrated in detail, it should be apparent that modifications and adaptations to those embodiments may occur to one skilled in the art without departing from the scope of the present invention as set forth in the following claims.

What is claimed is:

1. A tape rewind method, comprising:
rewinding elongate tape onto a supply reel at rewind velocity under tension;
upon said rewinding approaching an end of said elongate tape, rewinding said elongate tape at a reduced velocity under tension, said reduced velocity less than 60% of said rewind velocity; and
stopping said reduced velocity rewinding for a period of time and maintaining said elongate tape in a dwell state under tension.

2. The tape rewind method of claim 1, wherein said dwell state tension is greater than an operating tension during tape motion.

3. The tape rewind method of claim 2, wherein said dwell state tension comprises at least 50% greater tension than said operating tension during tape motion.

4. The tape rewind method of claim 2, wherein said dwell state period of time comprises substantially 10 seconds.

5. The tape rewind method of claim 1, wherein said reduced velocity rewind is conducted for at least 60 revolutions of said supply reel comprising at least 60 wraps of said elongate tape onto said supply reel.

6. The tape rewind method of claim 1, wherein said elongate tape comprises a magnetic data storage tape, said supply reel is in a data storage cartridge, said elongate tape is rewound from a take-up reel of a data storage drive, and said dwell state tension is developed between said supply reel and said take-up reel with respect to said elongate tape.

7. The tape rewind method of claim 6, wherein said elongate tape comprises a magnetic data storage tape whose end comprises a leader that is coupled to said take-up reel, and wherein said rewinding steps are followed by an unspool step which unspools all of said magnetic tape from said take-up reel onto said supply reel, and said unspool step precedes said dwell state step.

8. A tape drive, comprising:
a rotatable take-up reel, comprising a support for an end of an elongate tape;
a drive control system for rotating said take-up reel and for rotating a supply reel of a removable tape cartridge, said supply reel supporting the other end of said elongate tape, said drive control system for moving said elongate tape between said supply reel and said take-up reel and developing tension between said supply reel and said take-up reel with respect to said elongate tape:
rewinding said elongate tape onto said supply reel at rewind velocity under tension;
upon said rewinding approaching an end of said elongate tape, rewinding said elongate tape at a reduced velocity under tension, said reduced velocity less than 60% of said rewind velocity; and
stopping said reduced velocity rewinding for a period of time and maintaining said elongate tape in a dwell state under tension.

9. The tape drive of claim 8, wherein said dwell state tension is greater than an operating tension during tape motion.

10. The tape drive of claim 9, wherein said dwell state tension comprises at least 50% greater tension than said operating tension during tape motion.

11. The tape drive of claim 9, wherein said dwell state period of time comprises substantially 10 seconds.

12. The tape drive of claim 8, wherein said drive control system conducts said reduced velocity rewind for at least 60 revolutions of said supply reel comprising at least 60 wraps of said elongate tape onto said supply reel.

13. The tape drive of claim 8, wherein said elongate tape comprises a magnetic data storage tape whose end comprises a leader that is coupled to said take-up reel, and wherein said drive control system follows said rewinding steps with an unspool step which unspools all of said magnetic tape from said take-up reel onto said supply reel, and said unspool step precedes said dwell state step.

14. A drive control system for a tape drive, said tape drive comprising a rotatable take-up reel, comprising a support for an end of an elongate tape; and a drive system for rotating said take-up reel and for rotating a supply reel of a removable tape cartridge, said supply reel supporting the other end of said elongate tape; said drive control system comprising:
a system for operating said drive system to:
rewind said elongate tape onto said supply reel at rewind velocity under tension;
upon said rewind approaching an end of said elongate tape, rewind said elongate tape at a reduced velocity under tension, said reduced velocity less than 60% of said rewind velocity; and
stop said reduced velocity rewind for a period of time and maintain said elongate tape in a dwell state under tension.

15. The drive control system of claim 14, wherein said dwell state tension is greater than an operating tension during tape motion.

16. The drive control system of claim 15, wherein said dwell state tension comprises at least 50% greater tension than said operating tension during tape motion.

17. The drive control system of claim 15, wherein said dwell state period of time comprises substantially 10 seconds.

18. The drive control system of claim 14, wherein said drive control system conducts said reduced velocity rewind for at least 60 revolutions of said supply reel comprising at least 60 wraps of said elongate tape onto said supply reel.

19. The drive control system of claim 14, wherein said elongate tape comprises a magnetic data storage tape whose end comprises a leader that is coupled to said take-up reel, and wherein said drive control system follows said rewinding steps with an unspool step which unspools all of said magnetic tape from said take-up reel onto said supply reel, and said unspool step precedes said dwell state step.

20. The drive control system of claim 14, comprising a computer program product comprising non-transient computer-usable storage medium having computer-usable program code embodied therein, said computer-usable program code operating at least one computer processor system to operate said tape drive.
